(19) United States
(12) Patent Application Publication
(10) Pub. No.: US 2003/0154155 A1
(43) Pub. Date: Aug. 14, 2003

(54) Establishing auditable records of the process of agreement of contract by multiple participants in a service

(76) Inventors: Jeremy John Carroll, Bristol (GB); Todd A. Fischer, Boise, ID (US); Shell Sterling Simpson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/075,544

(22) Filed: Feb. 13, 2002

(51) Int. Cl. G06F 17/60

(52) U.S. Cl. 705/37

(57) ABSTRACT

A method of establishing auditable records of the process of agreement of contract by multiple participants in a service which operates over a computer network which has a customer and a vendor which negotiate during a contract formation phase of a transaction and in which a product or service is supplied to the customer during a contract execution phase of the transaction, includes providing a contract manager which monitors communications between the parties relating at least to the contract formation phase of the transaction, and keeps auditable records of the negotiations so as maintain an independent record of the agreed contract.

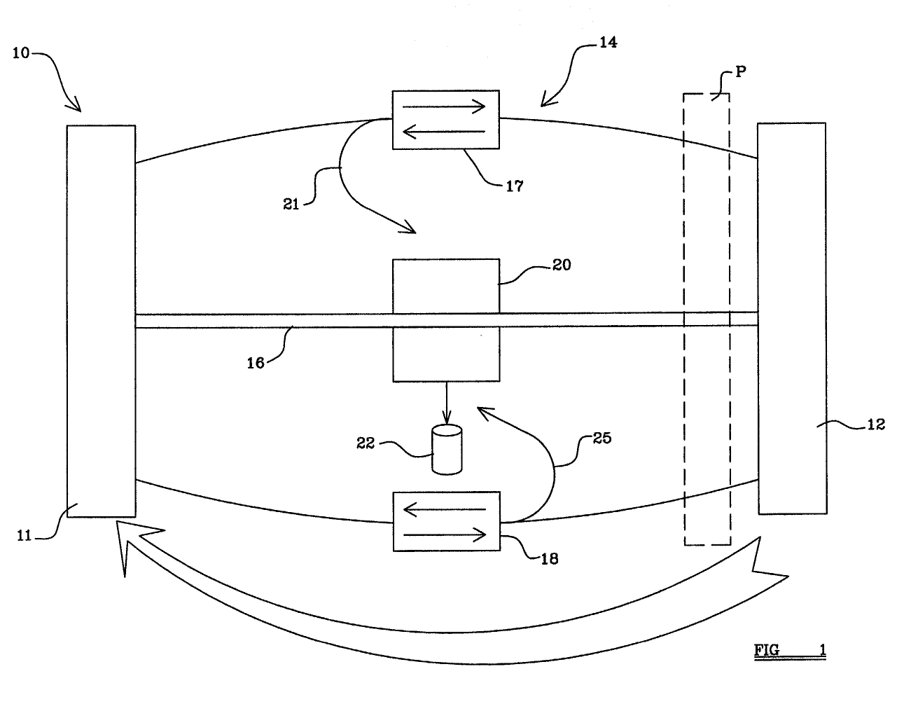

### BACKGROUND TO THE INVENTION

This invention relates to a method of establishing auditable records of the process of agreement of contract by multiple participants in a service, particularly an e-service.

An e-service is a service invoked over a computer network, for which there is accounting so that a seller providing a product or service can identify the buyer and achieve payment for the service or product the seller supplies. In respect of any e-service transaction, there is a contract formation phase during which an e-vendor typically a network enabled device of a product or service seller, negotiates with an e-customer which typically includes a network enabled device of a product or service buyer, and a contract execution phase during which the seller provides the product or service to the buyer.

The buyer may be a consumer of the product or service or an intermediary with whom the seller is contracted to supply the product or service; the seller may be an originator of the product or service, such as a manufacturer of a product, or may be an intermediary with whom the buyer enters a contract for the supply of the product or service. Other complex e-service supply chains are possible involving any number parties to any e-transaction. The party to the e-service requiring a product or service will hereinafter be referred to as an e-customer, and any party with whom the e-customer communicates for the purposes of the transaction will hereinafter be referred to an the e-vendor, although the e-vendor may not be the eventual supplier of the product or service to the e-customer.

During the contract formation phase of the e-transaction, the parties may create a job ticket which details the business processes which need to be completed during the contract execution phase of the e-transaction. The job ticket may be modified several times during the contract formation phase, until eventually a contract is established.

In the event of a disagreement relating to the e-transaction, for example about how the e-seller is to be paid, the nature of the contract execution, or another commercial matter, problems may arise in establishing the final form of the contract particularly where there have been many changes, and because the contract is an electronic document and hence is not an immutable object.

### DESCRIPTION OF THE PRIOR ART

In conventional paper based business systems, an immutable paper contract document is established after any negotiation, and changes cannot be readily be made subsequent to signing, at least without visibly annotating the original contract document.

Moreover in a paper based business system, there may be a record of how the contract assumed the final form, through for example a sequence of telephone conversations and exchanges of paper documents, although examining such ad-hoc records may present practical difficulties.

### SUMMARY OF THE INVENTION

According to a first aspect of the invention we provide a method of establishing an auditable record of the process of agreement of contract by multiple participants in an e-service which operates over a computer network and which has an e-customer and an e-vendor which negotiate during a contract formation phase of an e-transaction and in which a product or service is supplied to the e-customer during a contract execution phase of the e-transaction, the method including providing a contract manager which monitors communications between the parties relating at least to the contract formation phase of the e-transaction, the contract manager keeping an auditable record of the negotiation so as maintain an independent record of the agreed contract.

Thus in the event of a dispute arising between the parties, for example relating to a provision of the contract, the parties may consult the contract manager to ascertain and check the relevant contract provision. By virtue of the contract manager keeping independent records, the contract manager may thus assist in resolving the dispute.

Preferably the contract manager maintains an auditable record of each step in the negotiation particularly in which a new contract term is proposed or a change to a previously proposed contract term is proposed or a proposed contract term is agreed, so that the party to the negotiation who made an initial proposal or proposed a modification to a previously proposed contract term, may subsequently be identified.

Preferably the contract manager is operated independently of the e-customer and the e-vendor, i.e. is neutral and not controlled by either party.

The parties may negotiate using a job ticket format, such as the Adobe/Heidleberg job ticket format where the contract relates to a printing service, with the job ticket being exchanged between the e-vendor and e-buyer during the contract formation phase of the transaction while the parties make proposals and counter proposals for the contract terms. However, because the contract manager is keeping a record of each step in the negotiation, it is not essential for the parties to exchange the entire job ticket in order to make a fresh proposal or propose a modification to a contract term, but the method may enable the parties to exchange a reference only to the contract being negotiated, along with any fresh proposal or proposal for a modification to any contract term.

Preferably the contract manager, in addition to monitoring communications between the parties during the contract formation phase of the e-transaction, monitors communications between the parties relating to the contract execution phase of the e-transaction, the contract manager keeping an auditable record of such communications so as to maintain an independent record of such communications.

Thus for example, in the event that the parties agree to a change in the negotiated contract during the contract execution phase of the e-transaction, a record of such change will be maintained, preferably along with an auditable record of which party proposed and which party agreed to such a change. Moreover in the event of a dispute arising in the future for example concerning any breach of the agreed-to contract terms, the contract manager, by having an auditable record of both contract formation and contract execution communications, is better placed to be an independent arbiter if desired by the parties.

Typically the parties to the e-transaction will each be connected to a network such as for example the Internet, an Intranet or a Virtual Private Network for examples. The contract manager is preferably connected to the network too so that the contract manager can passively monitor communications between the parties. The contract manager may be enabled by one or both or only upon agreement of the parties at an early stage in the contract formation negotiations, preferably prior to any contract terms being agreed to by the parties.

According to a second aspect of the invention we provide an e-service which operates over a computer network and which has an e-customer and an e-vendor which negotiate during a contract formation phase of an e-transaction and in which a product or service is supplied to the e-customer during a contract execution phase of the e-transaction, the e-service including a contract manager which monitors communications between the parties relating at least to the contract formation phase of the e-transaction, the contract manager keeping an auditable record of the negotiation so as maintain an independent record of the agreed contract.

The e-service may have any of the features of the e-service in which auditable records are kept by the method of the first aspect of the invention.

According to a third aspect of the invention we provide a contract manager for an e-service which operates over a computer network and which has an e-customer and an e-vendor which negotiate during a contract formation phase of an e-transaction and in which a product or service is supplied to the e-customer during a contract execution phase of the e-transaction, the contract manager in use, monitoring communications between the parties relating at least to the contract formation phase of the e-transaction, and the contract manager keeping an auditable record of the negotiation so as maintain an independent record of the agreed contract.

### BRIEF DESCRIPTION OF THE DRAWING

The invention will now be described with reference to the accompanying drawing which is a schematic view of an e-service in which auditable records are kept by the method of the invention.

### DESCRIPTION OF THE PREFERRED EMBODIMENTS

Referring to the drawing there is shown an e-service 10 which has an e-customer 11 and an e-vendor 12, each of the e-vendor 12 and e-customer 11 being connected to a network 14 which may be the Internet, an Intranet, a Virtual Private Network or any other network desired. During an e-service transaction, the two parties 11, 12 negotiate in order to establish a contract for the supply of goods or services from the e-vendor 12 to the e-customer, although the e-vendor could be an intermediary such as a broker such that the goods or services are supplied by another party, e.g. a downstream e-service supply chain supplier.

The goods or services are supplied during a contract execution phase of the e-transaction once the terms of the contract between the e-vendor 12 and e-supplier 11 have been agreed.

In the drawing, schematically the two phases of the e-transaction are shown to be separate phases separated by the line indicated at 16. Exchanges of communications between the e-vendor 12 and e-customer 11 during the contract formation phase of the e-transaction are indicated by the reference 17 and exchanges of communications between the e-vendor 12 and e-customer 11 during the contract execution phase of the e-transaction are indicated by the reference 18.

Two examples of typical e-transactions will now be described.

In a first example, an e-transaction relates to the supply of a printing service.

The e-customer 11 requires a printing job to be performed by the e-vendor 12 in which a specified number of copies of a multiple colour document of X pages are required to be printed and delivered to the e-customer within 3 days. The e-customer would prefer to pay less than $Y, but would compromise on that in order to achieve receipt of the completed print job within the 3 days available.

Accordingly, the e-customer 11 completes a job ticket e.g. a job ticket inspired by the Adobe/Heidleberg job ticket format, to set out the parameters of the print job and to state the e-customer's preferences.

As well as the essential information given by way of example above, the job ticket may include preferences such as the quality of paper to be used for the job (e.g. 80 gram woven white paper), whether double sided printing is desired, the method of binding the pages etc.

The e-customer 11 then sends this job ticket with these initial proposals for the print job, to the e-vendor 12.

Typically the e-vendor 12 will propose a change to one or more of these proposals and/or make a new proposal. For example the e-vendor 12 may propose an alternative higher price $Z for the job and may propose to use a specific manufacturer's paper. The job ticket with this fresh proposal (to use a particular manufacturer's product) and the modified proposal (alternative price) may then be returned to the e-customer 11 for consideration.

It will be appreciated that in a typical e-service set-up, the e-vendor 12 may respond to the e-customer's initial proposal automatically such that human intervention at the e-vendor 12 end of the e-transaction may not be required, although consideration of alternative print job parameters or of a proposed print job parameter by the e-customer may require human intervention.

If the alternative price proposed by the e-vendor 12 and the fresh proposal to use a particular manufacturer's paper for the print job are acceptable to the e-customer 11, the e-transaction contract may be settled with the e-customer 11 placing an order. However the e-customer 11 may propose alternative parameters, for example to maintain the price below $Y, such as for example for the e-vendor 12 to use a lower quality of paper, or of binding etc. for the print job. Thus the e-customer 11 may return the job ticket to the e-vendor 12 for further consideration.

And thus the negotiations may continue until the job parameters are agreed to by the parties 11, 12 and a contract for the supply of the print service is settled, and the e-customer 11 places an order.

Because the exchanges of communications during the contract formation phase of the transaction 17 are virtual over the network 14, the agreed contract is not immutable. Accordingly, in the event of a dispute arising between the e-customer 11 and e-vendor 12, there may be difficulties establishing exactly what was agreed between the parties. Of course, each party 11, 12 may keep its own records relating to the negotiation but there could be circumstances where such records do not agree.

In the example, the e-customer 11 may for example be delivered the print job which has used a quality of paper lower than that the e-customer 11 may believe that was agreed between the parties 11, 12, or the print job may be delivered later than the 3 days required by the e-customer 11; or the e-vendor 12 may not receive payment for the print job within a time frame the e-vendor 12 believes is stipulated in the contract agreed between the parties during the contract formation phase of the e-transaction.

In accordance with the invention, the e-service 10 includes a contract manager 20 which is preferably independent of the e-customer 11 and e-vendor 12 and is connected to the network 14. The contract manager 20 is configured to monitor the negotiations between the parties to the e-transaction during the contract formation phase of the e-transaction at least, and to provide a facility for independent dispute resolution in the event of a dispute arising between the e-customer 11 and e-vendor 12.

Each communication between the e-customer 11 and e-vendor 12 during the contract formation phase 17 of the e-transaction may result in a “write” call 21 to the contract manager 20, which thus logs such communications i.e. the identity of the sender, and nature of the communication, and stores such communications using an appropriate documented business process, in a store 22, as an auditable transaction.

The contract manger's 20 service may be invoked at the request of either of the parties 11, 12, for example by the first communication from the e-customer 11 to the e-vendor 12, or by the first communication from the e-vendor 12 to the e-customer 11, by such communication including a service request to the contract manager 20, which includes a reference to enable the contract manager 20 to identify communications relating to the e-transaction in question on the network 14.

Whereas in a conventional e-service in which there are negotiations between an e-vendor 12 and an e-customer 11, the job ticket is exchanged between the parties at each stage in the negotiations, it will be appreciated that by employing the present invention in which auditable records of the process of agreement of contract by the participants in the e-service are kept by the independent contract manager 20, for the purposes of negotiation, it is unnecessary for the job ticket to be so exchanged. Rather communications between the parties may include only changes to existing proposed contract terms, counter proposals or fresh proposals, provided that each communication includes the reference to the e-transaction.

In the event that a dispute arises, such as for example as identified above, i.e. in relation to the contract terms, the contract manager 20 may be consulted to ascertain definitively what contract terms were agreed to by the parties 11, 12, and may even determine which party 11, 12 proposed which contract term and at which stage the other party agreed to that contract term.

In the cases of the potential disputes indicated above by way of example, the contract manager 20 may prove that the parties 11, 12 agreed that a particular quality of paper would be used whereas the e-vendor 12 had supplied a lower quality of paper; or the contract manager 20 may be consulted to prove that the e-customer 11 agreed to an alternative delivery schedule of 4 days, not 3; or the contract manager 20 may be consulted to establish the agreed-to time frame for paying the e-vendor 12 for the print job.

It is common in e-service transactions for changes to be made subsequent to the contract being formed and settled, e.g. during the contract execution phase of the e-transaction.

In the example, the e-customer 11 may decide that the print job is required to be delivered more urgently than originally indicated, e.g. within 2 days, or for the print job to be delivered to a different delivery address to that given on the job ticket.

Such changes do not usually require a complete re-negotiation of the contract, but do result in a change in the print job parameters, but the contract may be re-negotiated if such changes, e.g. requested by the e-customer 11 are major. Such changes could result in a dispute subsequently, for example with the e-vendor 12 delivering the print job to the original rather than the different delivery address

Accordingly, preferably, the contract manager 20 not only monitors communications between the e-customer 11 and e-vendor 12 during the contract formation phase of the e-transaction, but also communications between the parties 11, 12 during the contract formation phase, as schematically indicated at 18 in the drawing.

Again, each communication between the e-customer 11 and e-vendor 12 during the contract execution phase 18 of the e-transaction may result in a “write” call 25 to the contract manager 20, which thus logs such communications and stores such communications using an appropriate documented business process, in the store 22, as auditable records.

For example, if subsequent to the contract formation phase 17, the e-customer 11 requests that the print job is delivered to an alternative delivery address, to which change the e-vendor 12 agrees, this exchange of communications 18 may be monitored by the contract manager 20 which thus maintains an auditable record of such change.

Again therefore, the contract manager 20 may be consulted in the event that a dispute arises subsequently.

In a second example an e-service 10 is used for the supply of goods, namely a vehicle. An initial communication from the e-customer may take the form an enquiry such as “I am looking for a <make><model><colour>. Have you got one?”

In response to such an enquiry, the e-vendor 12 may begin a transaction negotiation which is automated at the e-vendor's end of the transaction.

For example, the e-vendor 12 may send to the e-customer 11, details of a plurality of alternative vehicles which are available, for example in the form of a job template including a set of job tickets, one for each vehicle. Preferably, the e-vendor 12, from the e-customer's 11 initial enquiry selects from all vehicles which the e-vendor 12 is able to supply, a set of vehicles which most closely match the criteria set out by the e-customer 11, e.g. vehicles classified according to selected criteria, such as engine size or body style (saloon or coupe), etc.

The e-customer 11 may peruse the set of job tickets returned by the e-vendor 12 and if the e-customer 11 is interested in buying any of the vehicles, the e-customer 11 may then make an offer, or counter offer. For example, the job ticket for a vehicle in which the e-customer 11 is interested, may include a price indication set by the e-vendor 12. The e-customer 11 may offer a lower price which may or may not be acceptable to the e-vendor 12. Alternatively, the job ticket may not include an indication of price, but may invite offers, so that the e-vendor 12 may compare alternative offers and accept the highest offer.

In each case, when the price is agreed, a contract for the supply of a selected vehicle may be settled between the e-customer 11, and the e-vendor 12.

If desired, prior to the contract being finally settled, the e-vendor 12 may offer to the e-customer 11 an added service, such as a vehicle warranty, and negotiations may continue in respect of the added service, until the contract is settled.

In accordance with the invention, during all such negotiations between the parties, the contract manager 20 may monitor the negotiation, by logging the initial proposal, and any modification to any proposed contract terms, or any new proposal made during the course of the negotiations, and may keep, e.g. in store 22, an auditable record of the negotiation, so that the contract manager 20 may be consulted in the event of any dispute arising between the parties 11, 12.

Moreover, again, in the event of any communication between the parties 11, 12 during the contract execution phase of the e-transaction, before or during the supply of the vehicle to the e-customer, such communications may be monitored by the contract manager 20 and auditable records kept of such communications.

The contract manager 20 may be enabled to monitor communications relating to the e-transaction when the job template is sent from the e-vendor 12 to the e-customer 11, and the job template and each job ticket thereof, may include a reference by which the e-transaction may thereafter be identified.

Primarily the contract manager 20 would be invoked to protect the e-vendor 12 from misconstructions of the contract terms by the e-customer 11 or even deliberate alterations of records relating to the contract terms, and thus the contract manager 20 may be part of, or related to the e-vendor 12, although the contract manager 20, by generally passively monitoring communications relating to the e-transaction, is independent of the e-transaction in that the contract manager 20 makes no contribution to the negotiation or execution of the e-transaction.

Various modifications may be made without departing from the scope of the invention. In the two examples described above, the initial communication relating to the e-transaction is originated from the e-customer 11 but in another example may originate with the e-vendor 12, for example with the e-vendor 12 broadcasting to a plurality of potential e-customers 11 connected to the network 14, the availability of a particular product or service, but preferably to avoid the contract manager 20 monitoring all communications relating to such broadcast, the contract manager 20 is enabled once a specific e-transaction negotiation commences e.g. a potential e-customer responds to the broadcast communication.

It will be appreciated that the e-service 10 indicated in the drawing is a very simple e-supply chain, but the invention may be applied to a more complex supply chain in which e.g. there are one or more proxies between the e-customer 11 and the e-vendor 12, e.g. as indicated at P in dotted lines in the drawing, or in which there are a plurality of alternative e-vendors 12 with which the e-customer 11 competitively negotiates before placing any order, in which case the contract manager 20, or a plurality of contract managers, may monitor some or all of the negotiations, in order to provide auditable records of such negotiations.

If desired, e-mail messages exchanged during performance of the method of the invention may utilise cryptographic technology, e.g. digital signatures on all or selected messages.

Whereas the contract manager 20 is preferably independent, as in the examples described, i.e. is neutral and not operated for or by either the e-customer 11 or the e-vendor 12, it will be appreciated that the contract manager 20 may be operated for or by either the e-customer 11 or e-vendor, but in all cases, it is essential that the contract manager 20 is truly independently auditable so as to give the high level of confidence to the independence of the contract manager 20 in keeping an accurate auditable record of contract negotiations.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of establishing an auditable record of the process of agreement of contract by multiple participants in a service which operates over a computer network and which has a customer and a vendor which negotiate during a contract formation phase of a transaction and in which a product or service is supplied to the customer during a contract execution phase of the transaction, the method including providing a contract manager which monitors communications between the parties relating at least to the contract formation phase of the transaction, the contract manager keeping an auditable record of the negotiation so as maintain an independent record of the agreed contract.

2. A method according to claim 1 wherein the contract manager maintains an auditable record of each step in the negotiation.

3. A method according to claim 2 wherein the contract manager maintains an auditable record of at least one of each new contract term proposed, and any change to a previously proposed contract term proposed, and a proposed contract term being agreed, so that the party to the negotiation who made an initial proposal or proposed a modification to a previously proposed contract term, may subsequently be identified.

4. A method according to claim 1 wherein the contract manager is operated independently of the customer and the vendor

5. A method according to claim 1 wherein the parties negotiate using a job ticket format with the job ticket being exchanged between the vendor and the buyer during the contract formation phase of the transaction while the parties make proposals and counter proposals for the contract terms.

6. A method according to claim 1 wherein in performance of the method the parties exchange a reference only to the contract being negotiated, along with any fresh proposal or proposal for a modification to any contract term.

7. A method according to claim 1 wherein the contract manager, in addition to monitoring communications between the parties during the contract formation phase of the transaction, monitors communications between the parties relating to the contract execution phase of the transaction, the contract manager keeping an auditable record of such communications so as to maintain an independent record of such communications.

8. A method according to claim 1 wherein in the event that the parties agree to a change in the negotiated contract during the contract execution phase of the transaction, a record of such change is maintained by the contract manager along with an auditable record of which party proposed and which party agreed to such a change.

9. A method according to claim 1 wherein the contract manager is connected to the network and the contract manager generally passively monitors communications between the parties.

10. A method according to claim 1 wherein the contract manager is enabled by one or both or only upon agreement of the parties at an early stage in the contract formation negotiations prior to any contract terms being agreed to by the parties.

11. A service which operates over a computer network and which has a customer and a vendor which negotiate during a contract formation phase of a transaction and in which a product or service is supplied to the customer during a contract execution phase of the transaction, the service including a contract manager which monitors communications between the parties relating at least to the contract formation phase of the transaction, the contract manger keeping an auditable record of the negotiation so as maintain an independent record of the agreed contract.

12. A contract manager for a service which operates over a computer network and which has a customer and a vendor which negotiate during a contract formation phase of a transaction and in which a product or service is supplied to the customer during a contract execution phase of the transaction, the contract manager in use, monitoring communications between the parties relating at least to the contract formation phase of the transaction, and the contract manager keeping an auditable record of the negotiation so as maintain an independent record of the agreed contract.
